(19) United States
(12) Patent Application Publication
(10) Pub. No.: US 2015/0134417 A1
(43) Pub. Date: May 14, 2015

(54) METHODS, SYSTEMS, AND APPARATUS FOR DYNAMIC CONSUMER SEGMENTATION

(71) Applicant: Pascal Scoles, Collegeville, PA (US)

(72) Inventor: Pascal Scoles, Collegeville, PA (US)

(21) Appl. No.: 14/541,761

(22) Filed: Nov. 14, 2014

Related U.S. Application Data
(60) Provisional application No. 61/904,172, filed on Nov. 14, 2013.

(51) Int. Cl. G06Q 30/02

(52) U.S. Cl. CPC G06Q 30/0204; G06Q 30/0241
USPC 705/7.33

(57) ABSTRACT

Methods, systems, and apparatus for segmenting consumers into groups are described. Tracking information on a selected consumer and a rule comprising criteria for each of one or more groups of consumers may be obtained. The selected consumer may be assigned to each of the one or more groups based on the tracking information satisfying the corresponding rule criteria.

### PRIORITY

This application is a Non-Provisional of and claims the benefit of priority under 35 U.S.C. §119(e) from U.S. Provisional Application Ser. No. 61/904,172, entitled “METHODS, SYSTEMS, AND APPARATUS FOR DYNAMIC CONSUMER SEGMENTATION,” filed on Nov. 14, 2013 which is hereby incorporated by reference herein in its entirety.

### TECHNICAL FIELD

The present application relates generally to processing data in publication systems, and more specifically, in one example, to segmenting consumers into groups.

### BACKGROUND

A growing variety of online applications are enabling users to perform an increasing number of tasks online. A search for a product and/or service, for example, may produce a list of available items for purchase. Depending on the type of consumer, the consumer may be more or less likely to accept an offer.

### BRIEF DESCRIPTION OF THE DRAWINGS

Some embodiments are illustrated by way of example and not limitation in the figures of the accompanying drawings, in which:

FIG. 1 is a block diagram of an example electronic commerce system for monitoring and segmenting consumers, in accordance with an example embodiment;

FIG. 2 is a rules table of an example set of rules for segmenting consumers, in accordance with an example embodiment;

FIG. 3 is an example group table of defined groups of consumers, in accordance with an example embodiment;

FIG. 4 is a block diagram of an example apparatus for segmenting consumers into groups, in accordance with an example embodiment;

FIG. 5 is a flowchart for an example electronic commerce method for segmenting consumers, in accordance with an example embodiment;

FIG. 6A is an example user datapoint table, in accordance with an example embodiment;

FIG. 6B is an example rules table for segmenting consumers, in accordance with an example embodiment;

FIG. 6C is an example criteria component table for segmenting consumers, in accordance with an example embodiment;

FIG. 6D is an example rules component table for segmenting consumers, in accordance with an example embodiment;

FIG. 6E is an example user datapoint matrix, in accordance with an example embodiment;

FIG. 7 is a representation of an example user interface for segmenting consumers into groups and for reviewing the segmented groups, in accordance with an example embodiment;

FIG. 8 is a flowchart for an example user interface method for segmenting consumers, in accordance with an example embodiment;

FIG. 9 is a block diagram of an example apparatus for performing a search for products and/or services, in accordance with an example embodiment;

FIG. 10 is a block diagram illustrating an example mobile device, according to an example embodiment; and

FIG. 11 is a block diagram of a machine within which instructions may be executed for causing the machine to perform any one or more of the methodologies discussed herein.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, systems, and apparatus for segmenting consumers are described. Consumers of products and services may generally include retail consumers, distributors, small business owners, business representatives, corporate representatives, non-profit organizations, and the like. In one example embodiment, consumers may be dynamically segmented into groups by analyzing clickstream data, historical data, user behavior information, and the like. As used herein, “clickstream data” refers to data that identifies and tracks a consumer's online activity. For example, “clickstream data” may identify a consumer's activity interacting with an electronic commerce service or traversing an online workflow.

In one example embodiment, a user, such as a business user, may specify criteria that define a group and/or define rules for segmenting consumers into groups. The consumers may be known users or may be anonymous users. The segmented groups of users may be used by businesses, individuals, providers, advertisers, and the like to target advertising, marketing efforts, and the like to particular segments of consumers. In one example embodiment, each organization, such as a business, firm, partner, and the like, of a plurality of organizations may maintain its own set(s) of rules. In one example embodiment, a user may be segmented into one or more groups based on the rule set(s) of only one organization of the plurality of organizations.

In one example embodiment, a consumer may conduct a search for an item (e.g., an item available for sale). As used herein, an “item” may refer to a product, a service, a combination of a product and a service, and the like. The search result set may produce a list of available items of varying degrees of relevance. The consumer selects one or more items in the search result set that may be of interest to the consumer and on which the consumer may desire to receive additional information and/or execute a transaction. A consumer can continue the search activity and may eventually purchase an item, may suspend the search, or may abort the search. The consumer's activity may be tracked and may be used to characterize the consumer and segment the consumer into one or more groups.

In one example embodiment, a consumer's activity may be tracked and processed in real time. In one example embodiment, a consumer's activity may be tracked in real time and processed in non-real time. The access to group membership information may be performed in substantially real time.

In one example embodiment, each rule may comprise a set of criteria against which a user, such as a consumer, is compared and a set of one or more groups to which a consumer is assigned if the consumer meets the corresponding criteria. Criteria may include user characteristics, demographic information, behavior information, and the like. The set of criteria may be based on a set of data points. In one example embodiment, a set of 600 or more data points may be maintained for each user. A data point may be a user's birthdate, a user's location, a count of days since a last purchase, and the like.

In one example embodiment, the actions of an anonymous user (i.e., a user whose identity is at least initially unknown) are tracked. The user's actions may include web page views, mouse clicks, changing of an address, and the like. In one example embodiment, an action may include simply passing a cursor over a displayed element. For example, passing a cursor controlled by a mouse over an item for sale may be tracked as an action. An anonymous user may be tracked as a single unknown user over multiple online sessions. For example, a cookie, as is known in the art, may be maintained on a machine of the anonymous user to correlate an anonymous user's online session with a previous online session(s) of the user.

In one example embodiment, the identity of an anonymous user may be determined. For example, a user may enter identifying information, such as a name and address, when purchasing an item. The information, such as tracking information, obtained about the user while the user was anonymous may then be correlated with the identified user. For example, the tracking information and group assignments obtained for an anonymous user may be correlated and associated with the identified user.

In one example embodiment, the identification of an anonymous user or the login of a known user may trigger the analysis of historical data associated with the user to determine if the user should be assigned to one or more groups. Historical data may include demographic information, a transaction history, and the like.

In one example embodiment, a new rule set may be processed only when new user activity is received. In one example embodiment, in response to a submission of a new rule set, the new rule set may be processed against previously stored tracking information and/or historical data associated with one or more users and the users may be assigned to one or more groups based on the processing. In one example embodiment, rules corresponding to a group of which the user is already a member are not processed when tracking information is received.

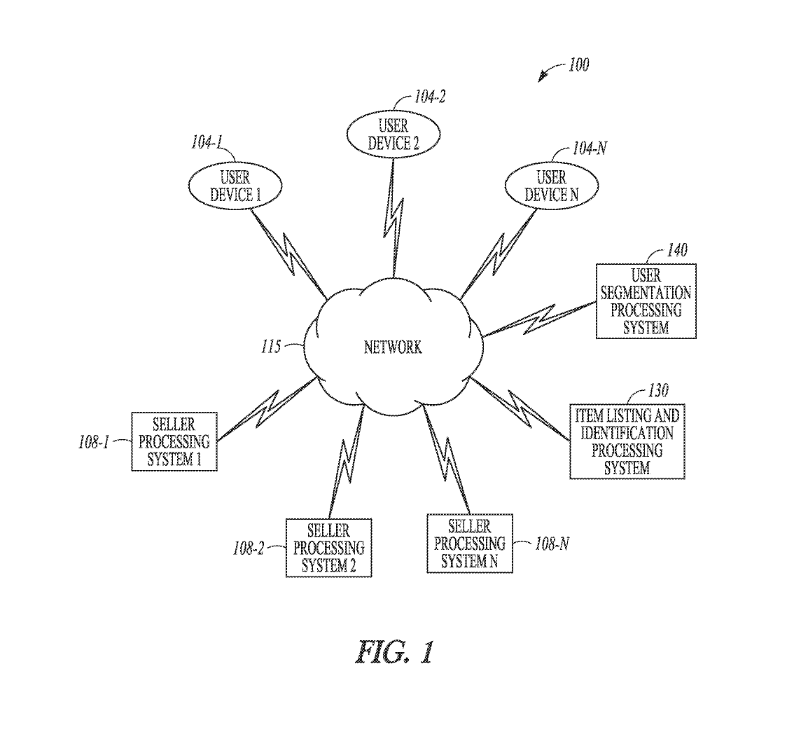

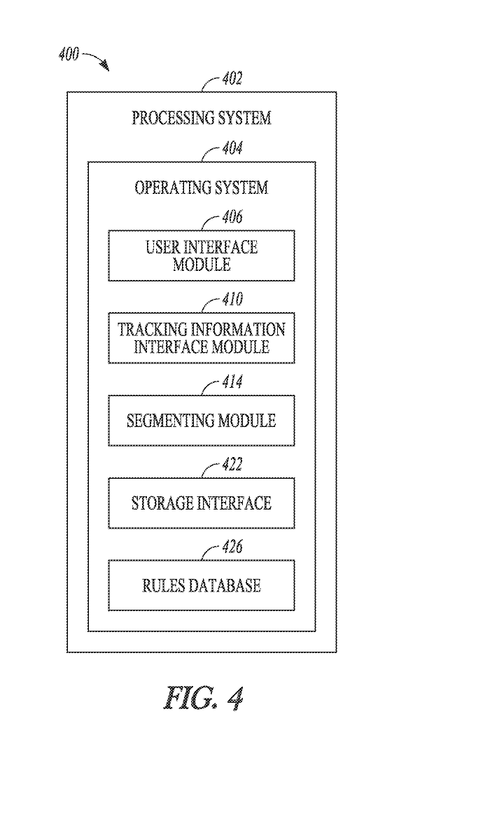

FIG. 1 is a block diagram of an example electronic commerce system 100 for monitoring and segmenting consumers, in accordance with an example embodiment. In one example embodiment, the electronic commerce system 100 may comprise one or more user devices 104-1, 104-2, and 104-N (known as user devices 104 hereinafter), one or more seller processing systems 108-1, 108-2, and 108-N (known as seller processing systems 108 hereinafter), an item listing and identification processing system 130, a network 115, and a user segmentation processing system 140. Each user device 104 may be a personal computer (PC), a tablet computer, a mobile phone, a personal digital assistant (PDA), a wearable computing device (e.g., a smartwatch), or any other appropriate computer device. Each user device 104 may include a user interface module, described more fully below in conjunction with FIG. 4. In one embodiment, the user interface module may comprise a web browser program. Although a detailed description is only illustrated for the user device 104-1, it is noted that each of the other user devices (e.g., user device 104-2 through user device 104-N) may have corresponding elements with the same functionality.

Each of the seller processing systems 108 and the item listing and identification processing system 130 may be a server, client, or other processing device that includes an operating system for executing software instructions. The seller processing systems 108 may provide items for sale to a consumer, and may facilitate the search for and purchase of the items to a variety of consumers.

The network 115 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, another type of network, a network of interconnected networks, a combination of two or more such networks, and the like.

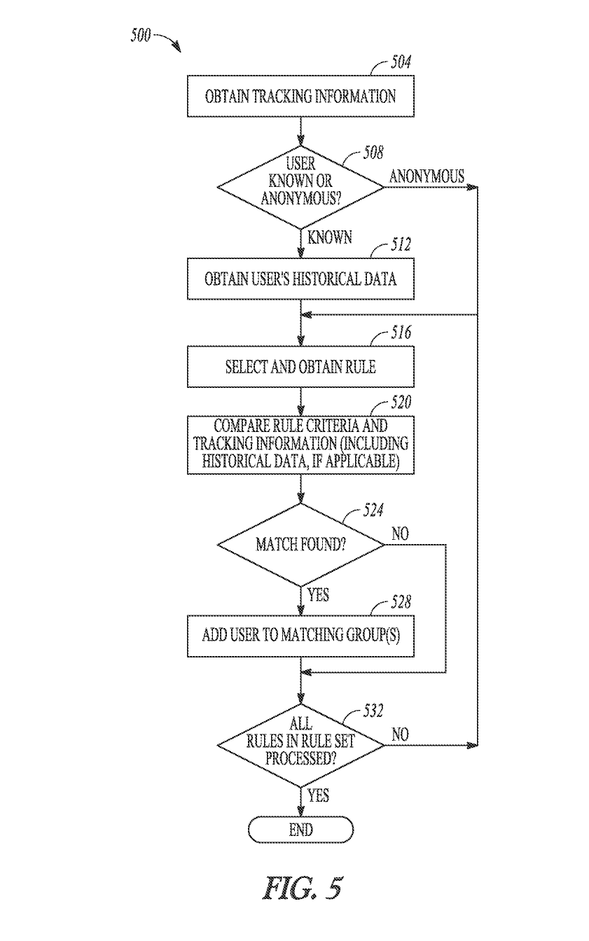

The user segmentation processing system 140 may segment consumers into groups by analyzing clickstream data, historical data, user behavior information, and the like. The segmentation may be based on a set of one or more rules, as described more fully below in conjunction with FIG. 5.

Each user device 104 may receive a query for item information from a user via an input device such as keyboard, mouse, electronic pen, etc. An item may comprise, for example, a product and/or a service, and the corresponding information may be in the form of an item listing.

The item listing and identification processing system 130 of an online listing system may store and/or obtain information related to items available for sale. Each item listing may comprise a detailed description of the item, a picture of the item, attributes of the item, and the like. The item associated with the item listing may be goods or a product (e.g., a tablet computer) and/or a service (e.g., a round of golf or an appliance repair) that may be transacted (e.g., by exchanging, sharing information about, buying, selling, making a bid on). The item listing may also include a title, a category (e.g., electronics, sporting goods, books, antiques), and attributes and tag information (e.g., color, size), and may be used to segment the user into one or more defined groups.

Referring back to the user device 104-1, the query received from the user of the user device 104-1 may comprise one or more keywords. The user device 104-1 may transmit the query to the item listing and identification processing system 130 via the network 115. The item listing and identification processing system 130 may attempt to match the query keywords with the title, the category, the tag information, and/or any other field in the item listing using a search engine.

In response to the submission of the search query, the item listing and identification processing system 130 may attempt to identify one or more item listings that satisfy the query. The item listing and identification processing system 130 may retrieve and then sort the item listings in the search result in a known manner. The item listing and identification processing system 130 may then return a sorted search result list to the user device 104-1 that submitted the query. The user may select one or more items in order to obtain additional information about the item and/or purchase the item. During the search and transaction, tracking information on the user may be obtained by the user segmentation processing system 140 and may be used to segment the user into one or more defined groups.

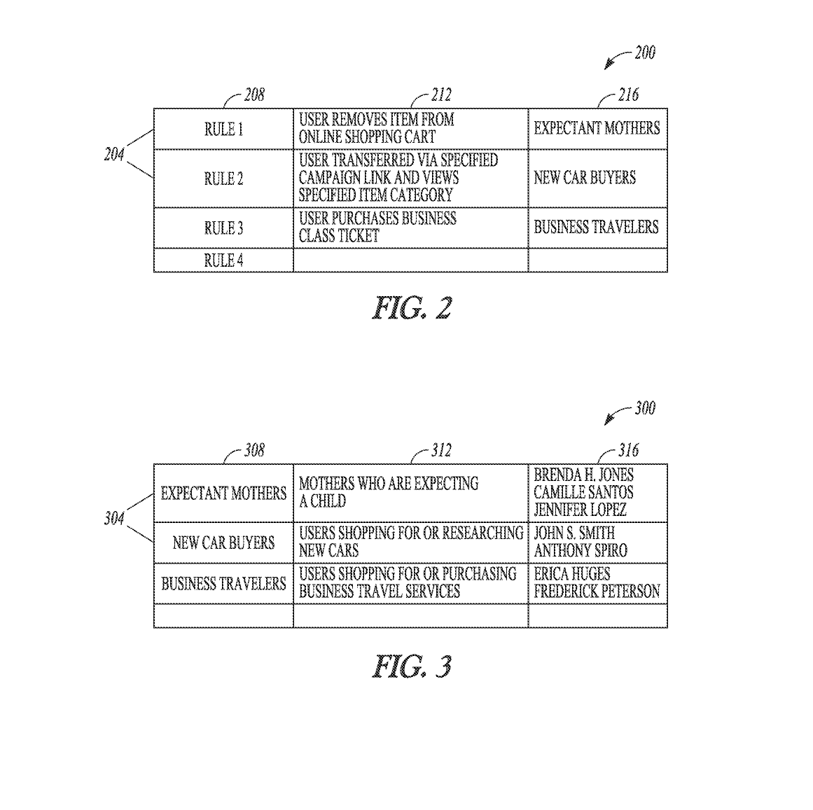

FIG. 2 is a rules table 200 of an example set of rules for segmenting consumers, in accordance with an example embodiment. Each rule may comprise a set of criteria against which a user (e.g., a consumer) may be compared and a set of one or more groups to which a user may be assigned if the user meets the specified criteria. Example criteria include consumer characteristics, demographic information, behavior information, and the like. Each row 204 of the rules table 200 may correspond to one rule. Column 208 may correspond to a rule identifier, column 212 may correspond to the set of criteria for the rule, and column 216 may correspond to one or more groups associated with the criteria.

FIG. 3 is an example group table 300 of defined groups of users (e.g., consumers), in accordance with an example embodiment. Each row 304 of the group table 300 may correspond to one defined group. Column 308 may correspond to a group identifier, column 312 may correspond to the set of criteria for the group, and column 316 may correspond to a list of one or more group members. Each group may comprise a set of criteria that defines the group and a list of one or more group members. The set of criteria may include consumer characteristics, demographic information, consumer behavior information, and the like. A group member may be an individual, or may be a group of individuals. For example, a group member may be a group of expectant mothers.

FIG. 4 is a block diagram of an example apparatus 400 for segmenting consumers into groups, in accordance with an example embodiment. The apparatus 400 is shown to include a processing system 402 that may be implemented on a client or other processing device that includes an operating system 404 for executing software instructions.

In accordance with an example embodiment, the apparatus 400 may include a user interface module 406, a tracking information interface module 410, and a segmenting module 414. In accordance with an example embodiment, the apparatus 400 may further include a storage interface 422 and a rules database 426.

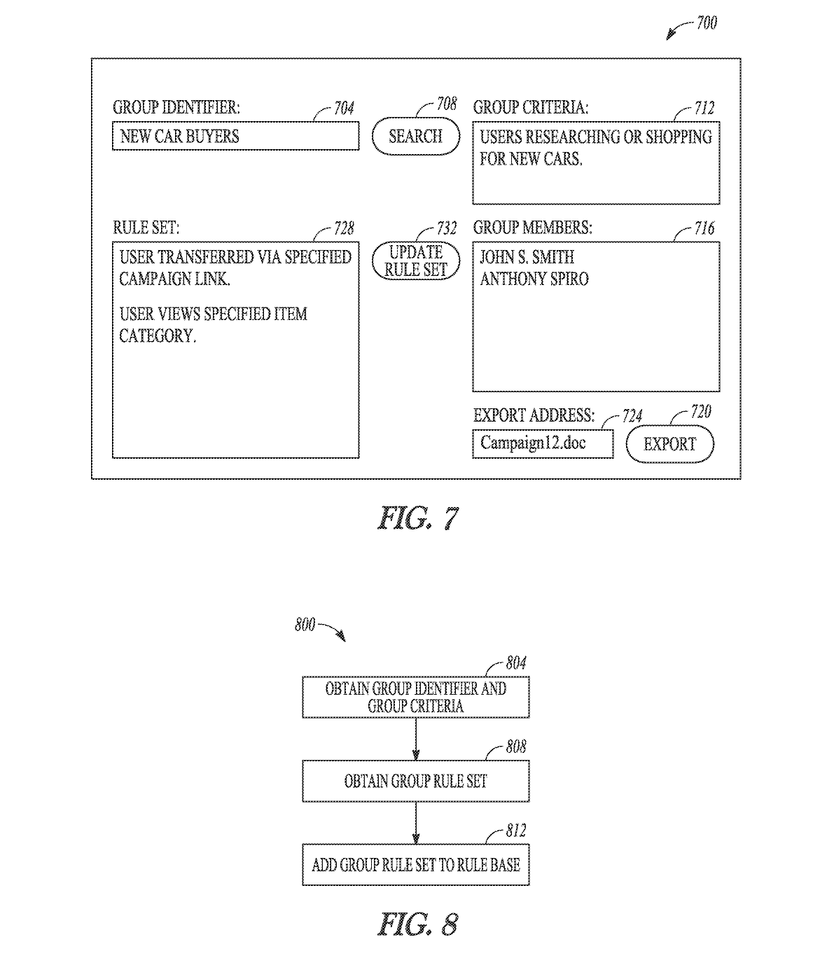

The user interface module 406 may enable a user to define criteria for one or more groups and may present to the user a set of one or more groups of users and the associated criteria that define each group, as described more fully below in conjunction with FIG. 7. In one example embodiment, the user interface module 406 comprises a dynamic rule interface for dynamically entering a rule set and/or dynamically modifying an existing rule set.

The tracking information interface module 410 may obtain clickstream data, historical data, user behavior information, and the like for one or more users. For example, the tracking information interface module 410 may obtain clickstream data and historical data from the seller processing systems 108 and the item listing and identification processing system 130.

The segmenting module 414 may segment consumers into groups based on the rules table 200. For example, the segmenting module 414 may perform the electronic commerce method for segmenting users, as described more fully below in conjunction with FIG. 5. In one example embodiment, the segmenting module 414 may dynamically segment users in response to a submission of a new rule set, in response to a modification of an existing rule set, and/or in response to a request for user segmentation information. For example, the segmenting module 414 may dynamically segment users in response to a request to provide a list of members of a group and/or in response to a request to provide a list of groups to which a user belongs. The dynamic segmentation may be based on previously tracked activity of the user.

The rules database 426 may comprise rules for segmenting users into groups. For example, the rules database 426 may comprise the rules table 200, as described more fully above in conjunction with FIG. 2.

FIG. 5 is a flowchart for an example electronic commerce method 500 for segmenting consumers, in accordance with an example embodiment. The electronic commerce method 500 may be performed by the segmenting module 414. In one example embodiment, the electronic commerce method 500 may be performed in response to a submission of a new rule set, in response to a modification of an existing rule set, and/or in response to a request for user segmentation information.

In one example embodiment, tracking information may be obtained for a selected user (operation 504). A test may be performed to determine if the user is an anonymous user or a known user (operation 508). If the user is a known user, historical data on the user may be obtained (operation 512); otherwise, the method may proceed with operation 516. The historical data may include previously tracked activity of the user.

A rule from the rules table 200 may be selected and obtained (operation 516). In one example embodiment, a rule is skipped over if the user is already assigned to all groups corresponding to the rule.

The obtained tracking information may be compared to the rule criteria (operation 520). For example, the rule criteria may be compared to the clickstream data, user behavior information, and the like associated with the user. The rule criteria may also be compared to the historical data associated with the user if the user is a known user. A test may be performed to determine if the rule criteria matches the tracking information associated with the user (operation 524).

If a match is found, the identity of the user may be added to the list of group members for each group identified by the corresponding rule (operation 528). For example, the identified groups in the group table 300 may be updated to include the identity of the user. In one example embodiment, a user may only be added to a list of group members if the user is a known user. In one example embodiment, a user may be added to a list of group members if the user is a known user or if the user is an anonymous user. If no match between the tracking information and the rule criteria is found, the method may proceed with operation 532.

A test may be performed to determine if all rules in the rules table 200 have been processed (operation 532). If all rules in the rules table 200 have been processed, the method may end; otherwise, the method may proceed with operation 516.

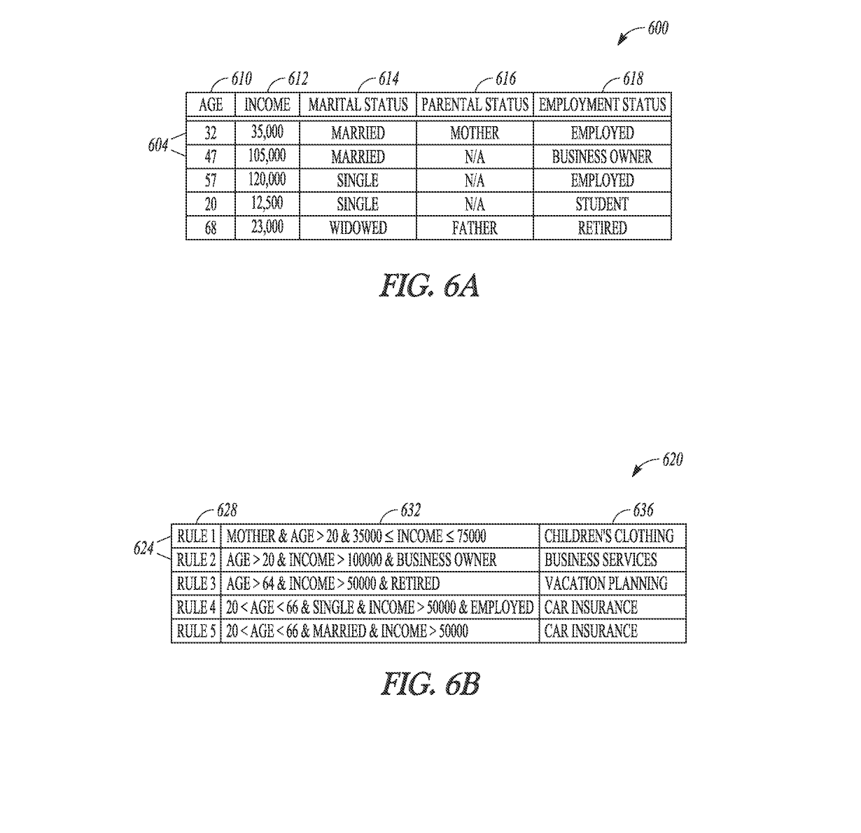

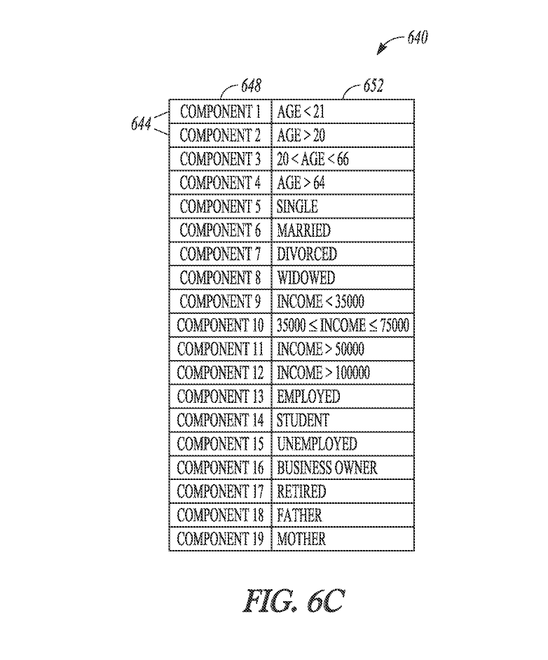

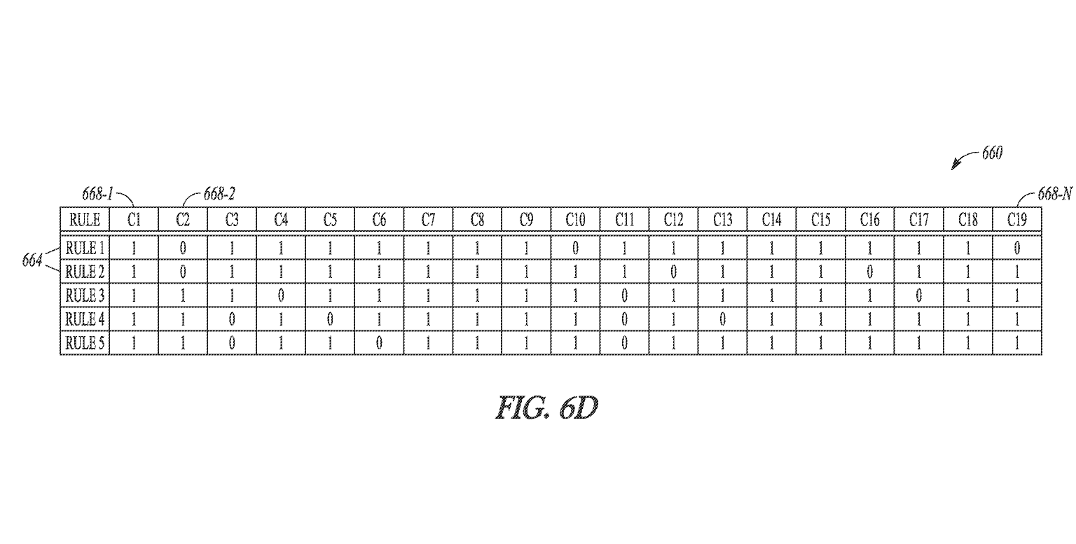

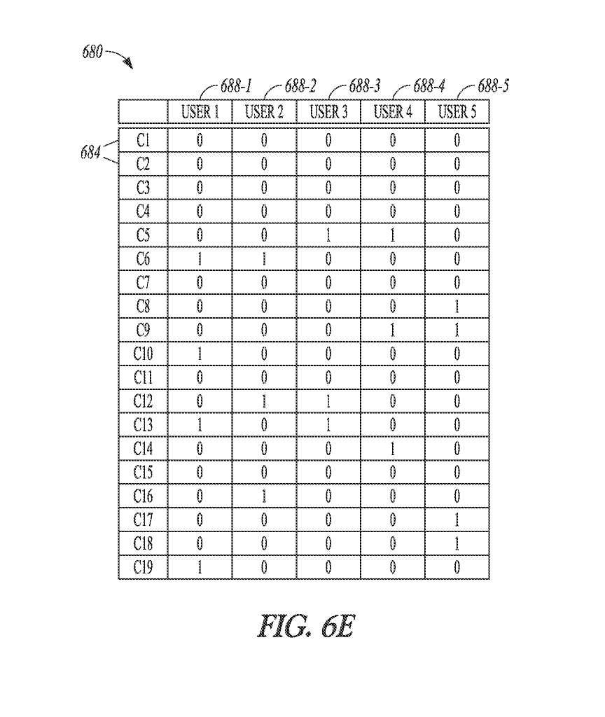

FIG. 6A is an example user datapoint table 600, in accordance with an example embodiment. Each row 604 of the user datapoint table 600 contains the datapoints corresponding to one user. Column 610 corresponds to the age of the corresponding user, column 612 corresponds to the income (per year) of the corresponding user, column 614 corresponds to the marital status of the corresponding user, column 616 corresponds to the parental status of the corresponding user, and column 618 corresponds to the employment status of the corresponding user. For example, the first user of the user datapoint table 600 is age 32, is a married mother, and is employed with an income of $35,000 per year.

FIG. 6B is an example rules table 620 of an example set of rules for segmenting consumers, in accordance with an example embodiment. Each rule may comprise a set of criteria against which a user (e.g., a consumer) may be compared and a set of one or more groups to which a user may be assigned if the user meets the specified criteria. Example criteria include consumer characteristics, demographic information, behavior information, and the like. Each row 624 of the rules table 620 may correspond to one rule. Column 628 may correspond to a rule identifier, column 632 may correspond to the set of criteria for the rule, and column 636 may correspond to one or more groups associated with the criteria. For example, Rule 1 indicates that users who are mothers with an age greater than 20 years and an income between $35,000 and $75,000, inclusive, should be added as members of the group Children's Clothing.

FIG. 6C is an example criteria component table 640 for segmenting consumers, in accordance with an example embodiment. Each rule of the rules table 620 may comprise criteria components against which a user (e.g., a consumer) may be compared. For example, the first criteria component of Rule 1 is the condition that the user is a mother, the second criteria component of Rule 1 is the condition that the age of the user is greater than 20 years, and the third criteria component of Rule 1 is the condition that the income of the user is between $35,000 and $75,000, inclusive. The rules criteria component table 640 contains a row 644 for each unique criteria component in the rules table 620. Column 648 may correspond to a criteria component identifier and column 652 may correspond to the criteria component. Thus, Rule 1 comprises criteria component 2, criteria component 10, and criteria component 19 of the criteria component table 640.

FIG. 6D is an example rules component table 660 for segmenting consumers, in accordance with an example embodiment. The rules component table 660 contains a row 664 for each rule in the rules table 620. Each column 668-1, . . . 668-N (hereinafter collectively known as columns 668) corresponds to a criteria component of the criteria component table 640. A value of zero in a column 668 indicates that the corresponding criteria component is a component of the corresponding rule, and a value of one in the column 668 indicates that the corresponding criteria component is not a component of the corresponding rule. For example, as described above, Rule 1 comprises criteria component 2, criteria component 10, and criteria component 19 of the criteria component table 640.

FIG. 6E is an example user datapoint matrix 680, in accordance with an example embodiment. The user datapoint matrix 680 contains a row 684 for each criteria component in the criteria component table 640. Each column 688-1, . . . 688-N (hereinafter collectively known as columns 688) of the user datapoint matrix 680 corresponds to a user. A value of one in a column 688 indicates that the condition of the corresponding criteria component is satisfied by the corresponding user, and a value of zero in the column 688 indicates that the condition of the corresponding criteria component is not satisfied by the corresponding user. For example, user 1 satisfies the conditions of criteria component 6, criteria component 10, criteria component 13, and criteria component 19 of the criteria component table 640.

In one example embodiment, the rules component table 660 and the user datapoint matrix 680 may be used to determine the rules that are satisfied by each user and thereby the groups to which each user belongs. For example, an “or” operation may be performed between each component of a selected rule in the rules component table 660 and the corresponding component of a selected user in the user datapoint matrix 680. If all of the results of the “or” operations are one for a selected rule and a selected user, then the selected rule is satisfied by the selected user and the user belongs to the group(s) identified by the rule. If any of the results of the “or” operations are zero for a selected rule and a selected user, then the selected rule is not satisfied by the selected user.

FIG. 7 is a representation of an example user interface 700 for segmenting consumers into groups and for reviewing the segmented groups, in accordance with an example embodiment. In one example embodiment, the user interface 700 may be utilized by the user device 104-1 to enable a user to define group criteria and/or view members of one or more segmented groups.

In one example embodiment, a group may be defined by entering a group name in a group identification field 704, entering group criteria in a group criteria display area 712, and entering rule(s) in a rule set display area 728. The group will be generated upon the user selecting an update rule set button 732.

In one example embodiment, a group name may be entered in the group identification field 704 and a search button 708 may be selected to initiate a display of the group. In one example embodiment, the group criteria may be displayed in the group criteria display area 712, the associated rule set may be displayed in the rule set display area 728, and one or more members of the group may be displayed in a group member display area 716.

In one example embodiment, a new rule may be added by entering the rule in the rule set display area 728 and selecting the update rule set button 732.

A user, such as a business user, may target the identified group for advertising, a marketing effort, and the like, by selecting an export button 720. In response, a formatted list of group members may be compiled and exported to a location identified in an export address field 724.

FIG. 8 is a flowchart for an example user interface method 800, in accordance with an example embodiment. In one example embodiment, one or more of the operations of the user interface method 800 may be performed by the user interface module 406.

A group identifier may be obtained via the group identification field 704 and group criteria may be obtained via the group criteria display area 712 (operation 804). One or more rules may be obtained via the rule set display area 728 (operation 808). The obtained rules may be added to the rules table 200 (operation 812).

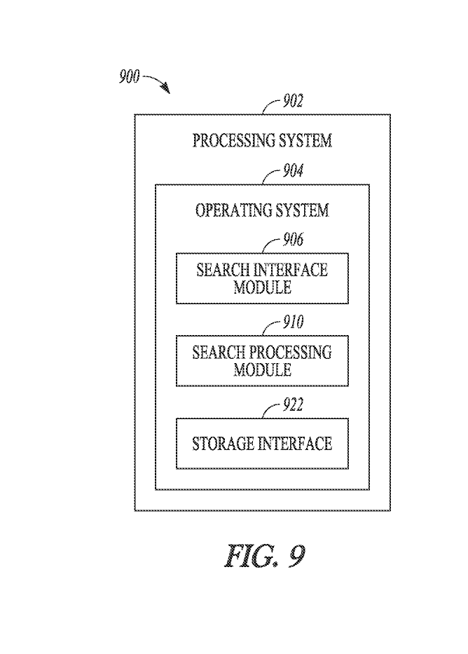

FIG. 9 is a block diagram of an example apparatus 900 for performing a search for products and/or services, in accordance with an example embodiment. The apparatus 900 is shown to include a processing system 902 that may be implemented on a client or other processing device that includes an operating system 904 for executing software instructions. In accordance with an example embodiment, the apparatus 900 may include a search interface module 906 and a search processing module 910. In accordance with an example embodiment, the apparatus 900 may further include a storage interface 922. In one example embodiment, the apparatus 900 may be a component of the item listing and identification processing system 130.

The search interface module 906 may obtain search terms and consumer filter selections from the user device 104-1, may provide a search result list to the user device 104-1, and may obtain consumer item selections from the user device 104-1. The search processing module 910 may conduct a search for items based on the search terms and consumer filter selections from the user device 104-1, and may generate the search result list for the user device 104-1. The storage interface 922 may provide access to databases containing item listings. For example, the storage interface 922 may provide access to listings within the seller processing systems 108.

Although certain examples are shown and described herein, other variations exist and are within the scope of the invention. It will be appreciated by those of ordinary skill in the art that any arrangement which is designed or arranged to achieve the same purpose may be substituted for the specific embodiments shown. This application is intended to cover any adaptations or variations of the example embodiments of the invention described herein. It is intended that this invention be limited only by the claims, and the full scope of equivalents thereof.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 115 (e.g., the Internet) and via one or more appropriate interfaces (e.g., application program interfaces (APIs)).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a network 115.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

A computing system can include clients and servers. A client and server are generally remote from each other and typically interact through a network 115. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

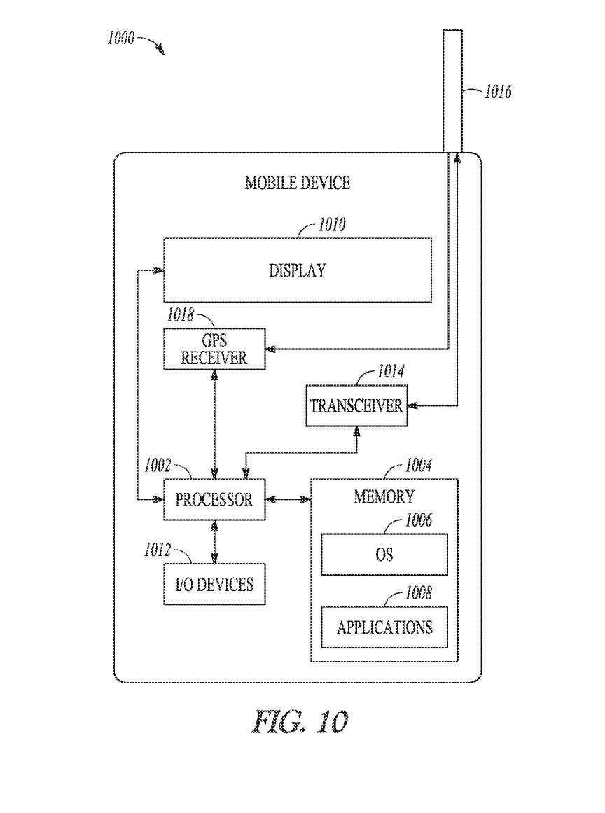

FIG. 10 is a block diagram illustrating an example mobile device 1000, according to an example embodiment. The mobile device 1000 can include a processor 1002. The processor 1002 can be any of a variety of different types of commercially available processors suitable for mobile devices 1000 (for example, an XScale architecture microprocessor, a Microprocessor without Interlocked Pipeline Stages (MIPS) architecture processor, or another type of processor). A memory 1004, such as a random access memory (RAM), a Flash memory, or another type of memory, is typically accessible to the processor 1002. The memory 1004 can be adapted to store an operating system (OS) 1006, as well as applications 1008, such as a mobile location enabled application that can provide location based services (LBSs) to a user. The processor 1002 can be coupled, either directly or via appropriate intermediary hardware, to a display 1010 and to one or more input/output (I/O) devices 1012, such as a keypad, a touch panel sensor, and a microphone. Similarly, in some embodiments, the processor 1002 can be coupled to a transceiver 1014 that interfaces with an antenna 1016. The transceiver 1014 can be configured to both transmit and receive cellular network signals, wireless data signals, or other types of signals via the antenna 1016, depending on the nature of the mobile device 1000. Further, in some configurations, a GPS receiver 1018 can also make use of the antenna 1016 to receive GPS signals.

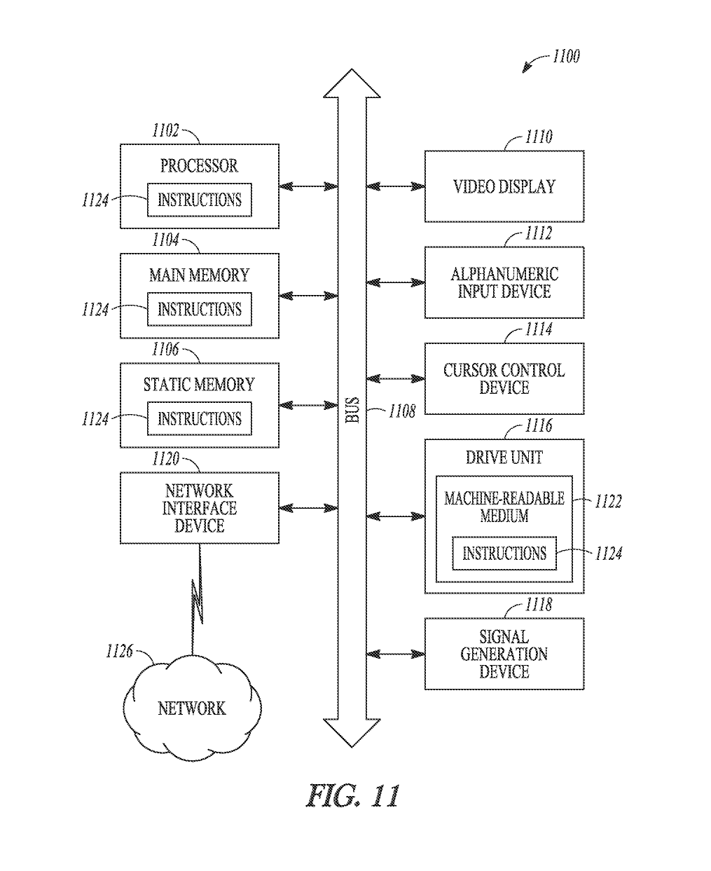

FIG. 11 is a block diagram of a machine in the form of an example computer system 1100 within which instructions may be executed for causing the machine to perform any one or more of the methodologies discussed herein. In one example embodiment, the machine may be the example apparatus 400 of FIG. 4 for segmenting consumers into groups. In one example embodiment, the machine may be the example apparatus 900 of FIG. 9 for performing a search for products and/or services. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU), or both), a main memory 1104, and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a cursor control device 1114 (e.g., a mouse), a drive unit 1116, a signal generation device 1118 (e.g., a speaker), and a network interface device 1120.

### Machine-Readable Medium

The drive unit 1116 includes a machine-readable medium 1122 on which is stored one or more sets of instructions and data structures (e.g., software) 1124 embodying or utilized by any one or more of the methodologies or functions described herein. The instructions and data structures 1124 may also reside, completely or at least partially, within the main memory 1104 and/or within the processor 1102 during execution thereof by the computer system 1100, the main memory 1104 and the processor 1102 also constituting machine-readable media. The instructions and data structures 1124 may also reside within the static memory 1106.

While the machine-readable medium 1122 is shown in an example embodiment to be a single medium, the term “machine-readable medium” may include a single medium or multiple media (e.g., a centralized or distributed database, and/or associated caches and servers) that store the one or more instructions and data structures 1124. The term “machine-readable medium” shall also be taken to include any tangible medium that is capable of storing, encoding, or carrying instructions and data structures 1124 for execution by the machine and that cause the machine to perform any one or more of the methodologies of the present invention, or that is capable of storing, encoding, or carrying data structures utilized by or associated with such instructions and data structures 1124. The term “machine-readable medium” shall accordingly be taken to include, but not be limited to, solid-state memories, and optical and magnetic media. Specific examples of machine-readable media 1122 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions and data structures 1124 may further be transmitted or received over a communications network 1126 using a transmission medium. The instructions and data structures 1124 may be transmitted using the network interface device 1120 and any one of a number of well-known transfer protocols (e.g., Hypertext Transfer Protocol (HTTP)). Examples of communications networks 1126 include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions and data structures 1124 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus for processing consumer data in an online publication system comprising:
an analytics module, executing on at least one computer processor, to:
obtain tracking information on a selected consumer;
obtain a rule comprising criteria for each of one or more groups of consumers; and
assign the selected consumer to one or more of the one or more groups based on the tracking information satisfying the corresponding rule criteria.

2. The apparatus of claim 1, wherein the at least one computer processor is further configured to analyze one or more of clickstream data, historical data, and user behavior data to determine if the rule criteria are satisfied.

3. The apparatus of claim 2, wherein the at least one computer processor is further configured to track an anonymous user over multiple sessions to derive the user behavior data.

4. The apparatus of claim 3, wherein the at least one computer processor is further configured to correlate the user behavior data derived for the anonymous user with a learned identity of the anonymous user.

5. The apparatus of claim 4, wherein the at least one computer processor is further configured to trigger an analysis of the historical data utilizing the obtained rule in response to learning the identity of the anonymous user.

6. The apparatus of claim 1, wherein a candidate rule is excluded if the selected consumer is a member of all groups corresponding to the candidate rule.

7. The apparatus of claim 1, wherein the assigning operation is performed in response to one or more of a submission of at least one new rule, a modification of at least one existing rule, and a receipt of a request for consumer segmentation information.

8. A method for processing consumer data in an online publication system, the method comprising:
obtaining tracking information on a selected consumer;
obtaining a rule comprising criteria for each of one or more groups of consumers; and
assigning the selected consumer to one or more of the one or more groups based on the tracking information satisfying the corresponding rule criteria.

9. The method of claim 8, the method further comprising analyzing one or more of clickstream data, historical data, and user behavior data to determine if the rule criteria are satisfied.

10. The method of claim 9, the method further comprising tracking an anonymous user over multiple sessions to derive the user behavior data.

11. The method of claim 9, the method further comprising correlating the user behavior data derived for the anonymous user with a learned identity of the anonymous user.

12. The method of claim 11, the method further comprising triggering an analysis of the historical data utilizing the obtained rule in response to learning the identity of the anonymous user.

13. The method of claim 8, wherein a candidate rule is excluded if the selected consumer is a member of all groups corresponding to the candidate rule.

14. The method of claim 8, wherein the assigning operation is performed in response to one or more of a submission of at least one new rule, a modification of at least one existing rule, and a receipt of a request for consumer segmentation information.

15. A non-transitory computer-readable medium embodying instructions that, when executed by a processor, perform operations comprising:
obtaining tracking information on a selected consumer;
obtaining a rule comprising criteria for each of one or more groups of consumers; and
assigning the selected consumer to one or more of the one or more groups based on the tracking information satisfying the corresponding rule criteria.

16. The non-transitory computer-readable medium of claim 15, the non-transitory computer-readable medium further embodying instructions that, when executed by a processor, perform operations comprising analyzing one or more of clickstream data, historical data, and user behavior data to determine if the rule criteria are satisfied.

17. The non-transitory computer-readable medium of claim 16, the non-transitory computer-readable medium further embodying instructions that, when executed by a processor, perform operations comprising tracking an anonymous user over multiple sessions to derive the user behavior data.

18. The non-transitory computer-readable medium of claim 16, the non-transitory computer-readable medium further embodying instructions that, when executed by a processor, perform operations comprising correlating the user behavior data derived for the anonymous user with a learned identity of the anonymous user.

19. The method of claim 18, the non-transitory computer-readable medium further embodying instructions that, when executed by a processor, perform operations comprising triggering an analysis of the historical data utilizing the obtained rule in response to learning the identity of the anonymous user.

20. The non-transitory computer-readable medium of claim 15, wherein a candidate rule is excluded if the selected consumer is a member of all groups corresponding to the candidate rule.
